(19) United States
(12) Patent Application Publication
(10) Pub. No.: US 2015/0220322 A1
(43) Pub. Date: Aug. 6, 2015

(54) SYSTEM AND METHOD FOR REINSTALLING, UPGRADING OR DOWNGRADING AN OPERATING SYSTEM

(71) Applicant: SRC, Inc., North Syracuse, NY (US)

(72) Inventors: Daniel T. Brown, Camden, NY (US); Karl David Mortensen, Annandale, VA (US)

(73) Assignee: SRC, INC., North Syracuse, NY (US)

(21) Appl. No.: 14/615,795

(22) Filed: Feb. 6, 2015

Related U.S. Application Data
(60) Provisional application No. 61/936,584, filed on Feb. 6, 2014.

(51) Int. Cl. G06F 9/445; G06F 9/44

(52) U.S. Cl. CPC G06F 8/65; G06F 9/4401

(57) ABSTRACT

A method and device for installing, reinstalling, upgrading, or downgrading an operating system. The method including the steps of: mounting, on a computing device having a primary memory and a secondary memory storing a first operating system, a virtual disk in the primary memory; installing, on the virtual disk an installation operating system; staging in the primary memory a desired operating system; staging in the primary memory an installation file configured to install the desired operating system in the secondary memory; and executing the installation file to install the desired operating system in the secondary memory.

### CROSS-REFERENCE TO RELATED APPLICATIONS

This application claims priority to U.S. Provisional Patent Application Ser. No. 61/936,584, filed on Feb. 6, 2014, the entire disclosure of which is incorporated herein by reference.

### STATEMENT OF GOVERNMENT INTEREST

This work derives from research under government contracts WI5P7T-12-C-A220 AND WI5P7T-12-D-M603. The U.S. government has rights in this invention.

### FIELD OF THE DISCLOSURE

The present disclosure relates to changing an operating system, generally, and specifically to changing an active operating system using an operating system running in memory.

### BACKGROUND

Upgrading an operating system on an embedded system without the use of external media is a time consuming, mechanically wearing, and ESD risky process. Current industry standard suggests building in a second “upgrade” partition to boot from to reinstall the primary partition. However, this technique is unable to accommodate systems with a single hard drive partition. Alternative methods that flip-flop between partitions are time-consuming and risk bricking the system. Accordingly there is a need in the art for a method for altering an operating system without external media that does not require removing the hard drive, that is also capable of accommodating otherwise incompatible file systems, and is efficient and reliable.

### SUMMARY

Exemplary aspects and embodiments in the present disclosure are directed to methods and system for installing, reinstalling, upgrading or downgrading an operating system. Various embodiments and implementations herein are directed to a method of installing a desired operating system in the secondary memory of a computing, from a virtual disk running in the primary memory of a computing device. Using the various embodiments and implementations herein, a desired operating system may be installed without removing a hard drive. In an exemplary aspect, a method for installing the operating system includes: mounting, on a computing device having a primary memory and a secondary memory storing a first operating system, a virtual disk in the primary memory; installing, on the virtual disk an installation operating system; staging in the primary memory a desired operating system; staging in the primary memory an installation file configured to install the desired operating system in the secondary memory; and executing the installation file to install the desired operating system in the secondary memory.

According to an embodiment, the method further comprises the step of deleting from the secondary memory at least part of the first operating system.

According to an embodiment, the step of deleting comprises deleting the entire operating system from the secondary memory.

According to an embodiment, the first operating system is an initial operating system.

According to an embodiment, the desired operating system is a portion of an operating system.

According to an embodiment, the method further comprises the step of rebooting the computing device.

According to an embodiment, the step of installing comprises adding the virtual disk to a PATH variable stored in the computing device.

According to another aspect, a method for modifying an operating system, comprises staging, on a virtual disk mounted in a primary memory of a computing device, a desired operating system; staging on the virtual disk an installation file configured to install the desired operating system in a secondary memory of the computing device; and running the installation file to install the desired operating system in the secondary memory.

According to an embodiment, the method further comprises the step of deleting from the secondary memory at least part of the first operating system.

According to an embodiment, the step of deleting comprises deleting the entire operating system from the secondary memory.

According to an embodiment, the first operating system is an initial operating system.

According to an embodiment, the desired operating system is a portion of an operating system.

According to an embodiment, the method further comprises the step of rebooting the computing device.

According to an embodiment, the step of installing comprises adding the virtual disk to a PATH variable stored in the computing device.

According to another aspect, a computer program configured to modify the operating system of a computer, implementing the steps of: mounting, on a computing device having a primary, memory and a secondary memory, a virtual disk in the primary memory; installing, on the virtual disk an installation operating system; staging in the primary memory a desired operating system; and staging in the primary memory an installation file configured to install the desired operating system in the secondary memory.

According to an embodiment, the installation file is configured to delete from the secondary memory of the computing device at least of part of an operating system.

According to an embodiment, the installation file is configured to delete the entire operating system from the secondary memory.

According to an embodiment, the desired operating system is a portion of an operating system.

According to an embodiment, the first operating system is an initial operating system.

According to an embodiment, the step of installing comprises adding the virtual disk to a PATH variable stored in the computing device.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 shows a block diagram of an operating system upgrade system according to an embodiment of the present invention.

FIG. 2 shows a flowchart of a method of changing an operating system according to an embodiment of the present invention.

FIG. 3 shows a method of changing an operating system according to an embodiment of the present invention.

### DETAILED DESCRIPTION

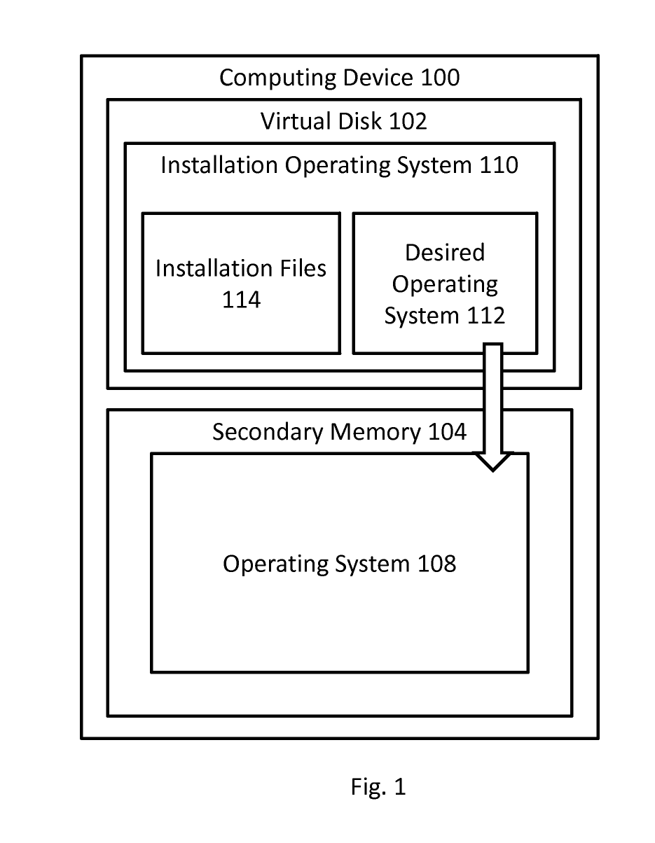

Referring now to the drawings, wherein like reference numerals refer to like parts throughout, there is shown in FIG. 1 a schematic of a computing device configured for reinstalling, replacing, upgrading, or downgrading (collectively referred to herein as “modifying”) an operating system without external boot media, according to an embodiment of the present invention.

As shown, computing device may have primary memory, hosting a virtual disk 106, and secondary memory 104 hosting an operating system 108. As will be understood by a person of ordinary skill in the art, primary memory refers to volatile, temporary memory, such as random access memory, and secondary memory refers to nonvolatile, permanent memory, such as a hard disk drive, solid state drive, etc. In an exemplary embodiment, operating system 108 may be the initial operating system. Herein, initial operating system refers to the operating system into which the computing system first boots. Secondary memory 104 may further be separated into multiple partitions, each hosting an operating system, such as an operating system 108 and a second operating system.

Virtual disk 106 may be configured to host an installation operating system 110 and to stage a desired operating system 112 and at least one installation file 114. Virtual disk 106 may be any block of primary memory 102 that may host an operating system, such as a RAM disk. Installation operating system 110 may be comprised of any operating system sufficient for running and managing the processes of an executable and/or script configured to install an operating system in secondary memory 104. For example, in one embodiment installation operating system 110 is a custom stripped-down version of the operating system 108, designed specifically for the task of installing a desired operating system 112. Installation file 114 may be a collection of scripts and/or executables programmed to install desired operating system 112.

Desired operating system 112 may be installed in place of an operating system already stored in secondary memory 104, including operating system 108, or in addition to any operating systems already stored in secondary memory. For example, desired operating system may be stored in a new partition in addition to the partition storing operating system 108. In this way, desired operating system 112 may be a new version, an older version, a clean copy of an operating system stored in secondary memory 104, or an entirely different operating system. For example, desired operating system 112 may be an upgrade, such as a patch to an operating system stored in secondary memory.

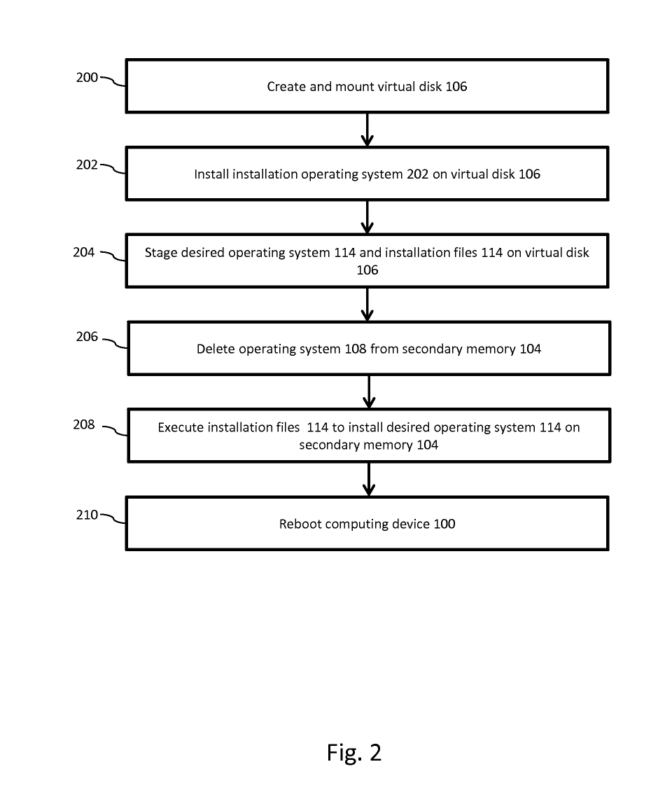

FIG. 2 shows a method, according to an embodiment, for modifying an operating system. In step 200, virtual disk 106 is mounted onto primary memory 102 of computing device 100. Next, in step 202, an installation operating system 110 is installed on virtual disk 106. As part of this step, the system PATH variable may be modified to include virtual disk, so virtual disk 106 will be referred to for any executables required in the process of installing desired operating system 112.

In step 204, the desired operating system 112 and the necessary installation files 114 are staged on virtual disk 106. In the preferred embodiment, desired operating system 112 may be staged in compressed file format such as a .tgz file or .zip file or .tar file. If multiple desired operating systems 112 are to be installed, each operating system must be staged prior to installation. Similarly, the installation files 114 must be configured to install each desired operating system 112 as is required. For example, if a first partition stores operating system 108 and a second partition stores a second operating system, operating system 108 may be modified with patch, while the second operating system may be reinstalled or modified in some other way. In each instance, both the patch and reinstall must be staged prior to installation, and installation files 114 must be configured to install each in their respective positions in secondary memory 104.

Steps 200-204 may be performed by software, such as a script, running on operating system 108, or on another operating system, such as an operating system stored in a second partition of secondary memory. Alternatively, steps 200-204 may also be performed completely or in part by a user. For example, virtual disk 106 may be mounted by a user, while steps 202-204 may be then completed by a script or other program.

In step 206, if an existing operating system, such as operating system 108, any portions of the operating system to be replaced may be deleted first. This step may comprise the steps of deleting all, or only a portion of, operating system 108. For example, or if a portion is corrupted and needs to be replaced, only that portion of operating system 108 need be deleted. Alternatively, If the entire operating system is to be deleted, the partition of secondary memory storing the partition may be deleted. If multiple operating systems stored in secondary memory are to be modified, portions of each operating system may be deleted as required. Note, that if a desired operating system 112 is to be installed without first deleting a portion of an existing operating system (i.e. the desired operating system is installed in addition to existing operating systems), this step need not be performed.

In step 208, the installation files 114 are executed to install the earlier staged desired operating system and install the desired operating system 112 on the new partition. As described above, if multiple desired operating systems 108 are to be installed, installation files 114 must be configured to implement any modifications to multiple operating systems, and each modification must be first staged on virtual disk 106. If a desired operating system 112 is to be installed on a new partition, the partition must be created initialized, and mounted prior to installing any operating system.

In the final step 210, computing device 100 is rebooted into newly installed desired operating system 112.

Steps 206-212 may be performed by software, such as a script, running on installation operating system 110. Alternatively, the steps 206 may be performed by a user. Similarly, executing installation files 114 and creating, initializing at least one partition, and rebooting the computing device 100 may all be performed by a user.

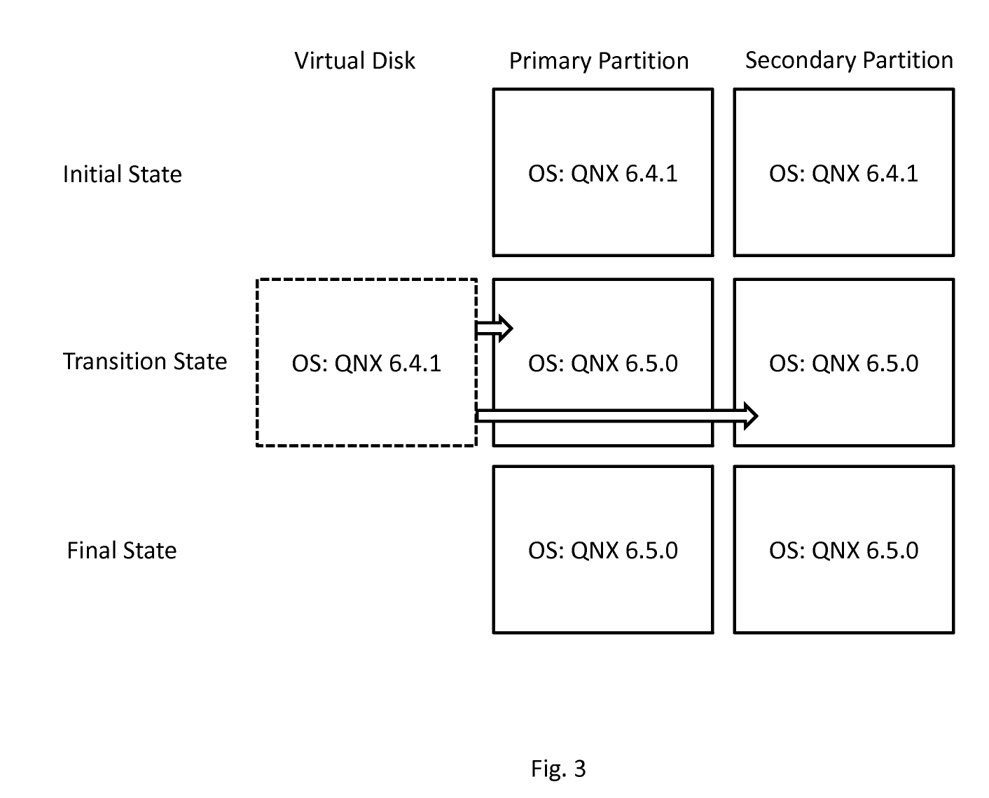

FIG. 3 shows an example of an embodiment of the present invention. The initial state shows a system having two partitions storing operating system QNX 6.4.1. Transition state shows an installation operating system 110 created in the virtual disk 106, staged with the appropriate software. The installation operating system 110 deletes the initial partitions and installs operating system QNX 6.5.0 into the primary and secondary partitions. In the final state, the system has been upgraded to the operating system QNX 6.5.0 in both partitions.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

A “module” or “component” as may be used herein, can include, among other things, the identification of specific functionality represented by specific computer software code of a software program. A software program may contain code representing one or more modules, and the code representing a particular module can be represented by consecutive or non-consecutive lines of code.

As will be appreciated by one skilled in the art, aspects of the present invention may be embodied/implemented as a computer system, method or computer program product. The computer program product can have a computer processor or neural network, for example, that carries out the instructions of a computer program. Accordingly, aspects of the present invention may take the form of an entirely hardware embodiment, an entirely software embodiment, and entirely firmware embodiment, or an embodiment combining software/firmware and hardware aspects that may all generally be referred to herein as a “circuit,” “module,” “system,” or an “engine.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction performance system, apparatus, or device.

The program code may perform entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowcharts/block diagrams in the Figures illustrate the architecture, functionality, and operation of possible implementations of systems, methods, and computer program products according to various embodiments of the present invention. In this regard, each block in the flowcharts/block diagrams may represent a module, segment, or portion of code, which comprises instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for modifying an operating system, comprising:
mounting, on a computing device having a primary memory and a secondary memory storing a first operating system, a virtual disk in the primary memory;
installing, on the virtual disk an installation operating system;
staging in the primary memory a desired operating system;
staging in the primary memory an installation file configured to install the desired operating system in the secondary memory; and
executing the installation file to install the desired operating system in the secondary memory.

2. The method of claim 1, further comprising the step of deleting from the secondary memory at least part of the first operating system.

3. The method of claim 3, wherein the step of deleting comprises deleting the entire operating system from the secondary memory.

4. The method of claim 1, wherein the first operating system is an initial operating system.

5. The method of claim 1, wherein the desired operating system is a portion of an operating system.

6. The method of claim 1, further comprising the step of rebooting the computing device.

7. The method of claim 1, wherein the step of installing comprises adding the virtual disk to a PATH variable stored in the computing device.

8. A method for modifying an operating system, comprising:
staging, on a virtual disk mounted in a primary memory of a computing device, a desired operating system;
staging on the virtual disk an installation file configured to install the desired operating system in a secondary memory of the computing device; and
running the installation file to install the desired operating system in the secondary memory.

9. The method of claim 8, further comprising the step of deleting from the secondary memory of the computing device at least part of a first operating system;

10. The method of claim 9, wherein the step of deleting comprises deleting the first entire operating system from the secondary memory.

11. The method of claim 9, wherein the first operating system is an initial operating system.

12. The method of claim 8, wherein the desired operating system is a portion of an operating system.

13. The method of claim 8, further comprising the step of rebooting the computing device.

14. The method of claim 8, wherein the step of installing comprises adding the virtual disk to a PATH variable stored in the computing device.

15. A computer program configured to modify the operating system of a computing device, implementing the steps of:
mounting, on a computing device having a primary memory and a secondary memory, a virtual disk in the primary memory;
installing, on the virtual disk an installation operating system;
staging in the primary memory a desired operating system; and
staging in the primary memory an installation file configured to install the desired operating system in the secondary memory.

16. The computer program of claim 15, wherein the installation file is configured to delete from the secondary memory of the computing device at least of part of an operating system.

17. The computer program of claim 16, wherein the installation file is configured to delete the entire operating system from the secondary memory.

18. The computer program of claim 16, wherein the desired operating system is a portion of an operating system.

19. The computer program of claim 15, wherein the first operating system is an initial operating system.

20. The computer program of claim 15, wherein the step of installing comprises adding the virtual disk to a PATH variable stored in the computing device.
